(19) United States
(12) Patent Application Publication
(10) Pub. No.: US 2024/0116699 A1
(43) Pub. Date: Apr. 11, 2024

(54) Trimmings Collection Skirt Device

(71) Applicant: Cecilia Ndungu, Mishawaka, IN (US)

(72) Inventor: Cecilia Ndungu, Mishawaka, IN (US)

(21) Appl. No.: 18/466,229

(22) Filed: Sep. 13, 2023

Related U.S. Application Data
(60) Provisional application No. 63/414,923, filed on Oct. 11, 2022.

(51) Int. Cl. B65F 1/00

(52) U.S. Cl. CPC B65F 1/002; B65F 2240/138

(57) ABSTRACT

A trimmings collection skirt device is provided. The device is comprised of a body that can be placed around a piece of greenery such as but not limited to a tree or shrub. Trimmings from the tree or shrub are then collected on the body. Then, the body of the device can be fastened to itself to form a bag-like structure which retains the trimmings. As a result, the trimmings can then be easily dumped or disposed of.

### CROSS-REFERENCE TO RELATED APPLICATION

The present application claims priority to, and the benefit of, U.S. Provisional Application No. 63/414,923, which was filed on Oct. 11, 2022, and is incorporated herein by reference in its entirety.

### FIELD OF THE INVENTION

The present invention relates generally to the field of landscaping. More specifically, the present invention relates to a trimmings collection skirt device that can be placed around a piece of greenery before trimming such that trimmings from the greenery will fall onto the device, and wherein the device can then be converted into a bag-like structure to secure the trimmings. Accordingly, the present disclosure makes specific reference thereto. Nonetheless, it is to be appreciated that aspects of the present invention are also equally applicable to other like applications, devices, and methods of manufacture.

### BACKGROUND

When it comes to maintaining a garden, yard, or other landscaped area, a common task that often poses unexpected challenges is the process of raking and transferring tree or shrub trimmings into a lawn bag. One common method is to position a lawn bag slightly open on the ground, and then attempt to shovel or sweep the trimmings inside. Yet, this often results in a good portion of the debris missing the target, leading to repeat efforts.

Moreover, another challenge arises when individuals try to transfer larger or bulkier trimmings. Since the bag tends to collapse or fold on itself, one hand is often required to hold the bag open, which then leaves only one other hand free to operate the tool. This juggling act between keeping the bag open and transferring the trimmings is not just time-consuming but can also lead to considerable frustration. Over time, this seemingly simple task can become a tedious and exhausting chore, highlighting the need for more efficient solutions or tools.

Therefore, there exists a long-felt need in the art for a device that can be used to collect trimmings. More specifically, there exists a long-felt need in the art for a trimmings collection skirt device that can be used to easily collect trimmings that have been trimmed from a piece of greenery. In addition, there exists a long-felt need in the art for a trimmings collection skirt device that can be used to easily collect trimmings that have been trimmed from a piece of greenery wherein the trimmings need not be raked or otherwise manipulated onto the device during use.

The subject matter disclosed and claimed herein, in one embodiment thereof, comprises a trimmings collection skirt device. The device is comprised of a body that can be placed around a piece of greenery such as but not limited to a tree or shrub. Trimmings from the tree or shrub are then collected on the body. Then, the body of the device can be fastened to itself to form a bag-like structure that retains the trimmings. As a result, the trimmings can then be easily dumped or disposed of.

In this manner, the trimmings collection skirt device of the present invention accomplishes all the forgoing objectives and provides a device that can be used to collect trimmings. More specifically, the device can be used to easily collect trimmings that have been trimmed from a piece of greenery without requiring that the trimmings be raked or otherwise manipulated onto the device during use.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a trimmings collection skirt device that can be used when trimming trees, shrubs, or any greenery of the like. More specifically, the body of the device can be placed around a shrub via a central opening. Then, the shrub can be trimmed, wherein the trimmings are collected on the body which surrounds the shrub. After trimming has been completed, the central opening can be closed using at least one fastener on the edge of the opening, and wherein the perimeter edge of the body can attach to itself to form a bag-like structure in order to secure the trimmings within the body.

The body is preferably circular and has at least one central opening. In this manner, a shrub or other small greenery can be placed through the opening such that the remainder of the body surrounds the shrub. The body can then be lifted upwards from around the greenery after trimming of the greenery has been completed. Then, the central opening of the body can be closed. The opening is preferably comprised of an edge with at least one fastener that allows the edge to attach to itself to close the opening. The fastener may be but is not limited to zipper, magnet, hook and loop, snap button, etc.

After the opening has been closed, the perimeter edge of the body can be attached to itself via at least one fastener on the perimeter edge. The fastener may be any fastener type such as but not limited to zipper, magnet, hook and loop, snap button, drawstring, etc. In this manner, the body can be formed into a bag-like shape such that the trimmings from the greenery are retained within the now-continuous body (due to the closing of the opening) and can be moved and disposed of as necessary.

The present invention is also comprised of a method of using the device. First, a device is provided comprised of a body comprised of a central opening and a perimeter edge with at least one fastener. Then, the central opening can be placed around a piece of greenery from. Next, the greenery can be trimmed, wherein the trimmings are collected on the body. Next, the body can be lifted upward such that the body no longer surrounds the greenery, and while the trimmings remain on the body. Then, the edge of the central opening can be secured to itself using at least one fastener positioned on the edge. Finally, the perimeter edge of the body can be attached to itself via at least one fastener positioned on the edge to form the body into a bag-like shape that retains the trimmings.

Accordingly, the trimmings collection skirt device of the present invention is particularly advantageous as it provides a device that can be used to collect trimmings. More specifically, the device can be used to easily collect trimmings that have been trimmed from a piece of greenery without requiring that the trimmings be raked or otherwise manipulated onto the device during use. In this manner, the trimmings collection skirt device provides a solution for collecting trimmings.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a trimmings collection skirt device of the present invention in accordance with the disclosed architecture;

FIG. 2 illustrates a perspective view of one potential embodiment of a trimmings collection skirt device of the present invention while around a piece of greenery in accordance with the disclosed architecture;

FIG. 3 illustrates a perspective view of one potential embodiment of a trimmings collection skirt device of the present invention with both edges of the slit unattached in accordance with the disclosed architecture;

FIG. 4 illustrates a perspective view of one potential embodiment of a trimmings collection skirt device of the present invention in bag form in accordance with the disclosed architecture;

FIG. 5 illustrates a flowchart of a method of using one potential embodiment of a trimmings collection skirt device of the present invention in accordance with the disclosed architecture; and

FIG. 6 illustrates a flowchart of a method of using one potential embodiment of a trimmings collection skirt device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that can be used to collect trimmings. More specifically, there exists a long-felt need in the art for a trimmings collection skirt device that can be used to easily collect trimmings that have been trimmed from a piece of greenery. In addition, there exists a long-felt need in the art for a trimmings collection skirt device that can be used to easily collect trimmings that have been trimmed from a piece of greenery wherein the trimmings need not be raked or otherwise manipulated onto the device during use.

The present invention, in one exemplary embodiment, is comprised of a trimmings collection skirt device. The device can be used when trimming trees, shrubs, or any greenery of the like. More specifically, the body of the device can be placed around a shrub via a central opening. Then, the shrub can be trimmed, wherein the trimmings are collected on the body which surrounds the shrub. After trimming has been completed, the central opening can be closed using at least one fastener on the edge of the opening. Then, the perimeter edge of the body can attach to itself to form a bag-like structure in order to secure the trimmings within the body.

The body is preferably circular and has at least one central opening. As a result, a shrub or other small greenery can be placed through the opening such that the remainder of the body surrounds the shrub. The body can then be lifted upwards from around the greenery after trimming of the greenery has been completed. Then, the central opening of the body can be closed. The opening is preferably comprised of an edge with at least one fastener that allows the edge to attach to itself to close the opening, wherein the fastener may be but is not limited to zipper, magnet, hook and loop, snap button, etc.

After the opening has been closed, the perimeter edge of the body can be attached to itself via at least one fastener on the perimeter edge. The fastener may be any fastener type such as but not limited to zipper, magnet, hook and loop, snap button, drawstring, etc. In this manner, the body can be formed into a bag-like shape such that the trimmings from the greenery are retained within the now-continuous body (due to the closing of the opening) and can be moved and disposed of as necessary.

The present invention is also comprised of a method of using the device. First, a device is provided comprised of a body comprised of a central opening and a perimeter edge with at least one fastener. Then, the central opening can be placed around a piece of greenery from. Next, the greenery can be trimmed, wherein the trimmings are collected on the body. Next, the body can be lifted upward such that the body no longer surrounds the greenery, and while the trimmings remain on the body. Then, the edge of the central opening can be secured to itself using at least one fastener positioned on the edge. Finally, the perimeter edge of the body can be attached to itself via at least one fastener positioned on the edge to form the body into a bag-like shape that retains the trimmings.

Accordingly, the trimmings collection skirt device of the present invention is particularly advantageous as it provides a device that can be used to collect trimmings. More specifically, the device can be used to easily collect trimmings that have been trimmed from a piece of greenery without requiring that the trimmings be raked or otherwise manipulated onto the device during use. In this manner, the trimmings collection skirt device provides a solution for collecting trimmings.

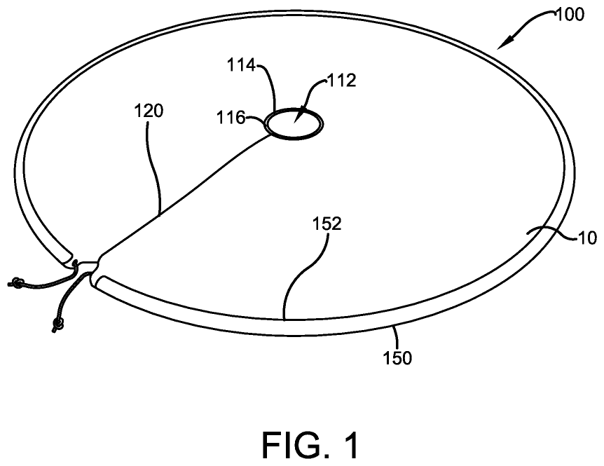

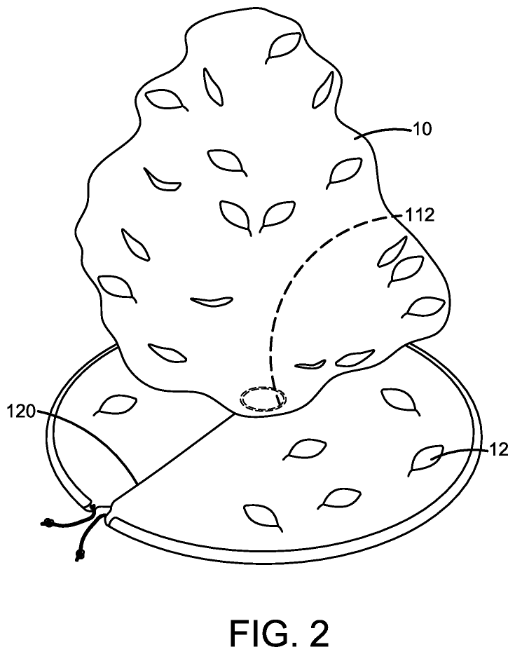

Referring initially to the drawings, FIG. 1 illustrates a perspective view of one potential embodiment of a trimmings collection skirt device 100 of the present invention in accordance with the disclosed architecture. The device 100 can be used when trimming trees, shrubs, or any greenery 10 of the like. More specifically, the body 110 of the device 100 can be placed around a shrub 10 via a central opening 112. Then, the shrub 10 can be trimmed, wherein the trimmings are collected on the body 110 which surrounds the shrub 10 (as seen in FIG. 2). After trimming has been completed, the central opening 112 can be closed using at least one fastener 116 on the edge 114 of the opening 112, and wherein the perimeter edge 150 of the body 110 can attach to itself to form a bag-like structure in order to secure the trimmings 12 within the body 110.

The body 110 is preferably made from a tear-resistant natural or synthetic fabric material. The body 110 is preferably circular, but may be any shape in different embodiments. The body 110 may also be multiple sizes to accommodate various shrub 10, treen, greenery, etc. sizes.

In one embodiment, the body 110 is comprised of at least one central opening 112 positioned in the center of the body 110. In this manner, a shrub 10 or other small greenery can be placed through the opening 112 such that the remainder of the body 110 surrounds the shrub 10.

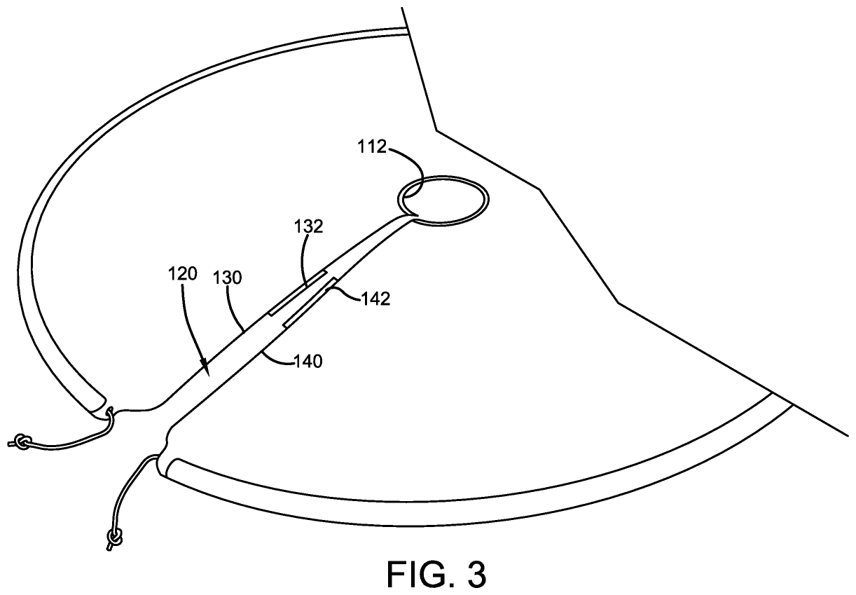

For larger and taller greenery such as trees 10, the body 110 can be partially separated by at least one slit 120 which connects to the central opening 112. This allows the body 110 to be easily placed around a large piece of greenery 10 without the need to place the opening 112 overtop the greenery 10. In said embodiment, both edges 130,140 of the slit 120 can be fastened to each other to make the body 110 continuous after it has been attached around greenery 10. In this embodiment, either or both edges 130,140 may be comprised of at least one fastener 132,142, as seen in FIG. 3. The fasteners 132,142 may be any reciprocating fastener type such as but not limited to zipper, magnet, hook and loop, snap button, etc.

In an embodiment with only a central opening 112, the body 110 can then be lifted upwards from around the greenery 10 after trimming of the greenery 10 has been completed. In an embodiment with a slit 120, the edges 130,140 of the slit 120 can be unfastened from each other and the body 110 can simply be pulled away from around the greenery 10. Then, the central opening 112 of the body 110 can be closed. The opening 112 is preferably comprised of an edge 114 with at least one fastener 116 that allows the edge 114 to attach to itself to close the opening 112. The fastener 116 may be but is not limited to zipper, magnet, hook and loop, snap button, etc.

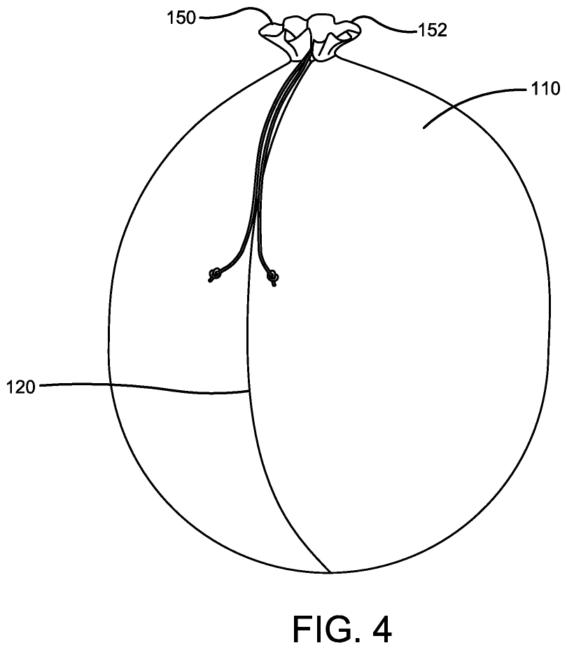

After the opening 112 has been closed, the perimeter edge 150 of the body 110 can be attached to itself via at least one fastener 152 on the perimeter edge 150. The fastener 152 may be any fastener type such as but not limited to zipper, magnet, hook and loop, snap button, drawstring, etc. In this manner, the body 110 can be formed into a bag-like shape such that the trimmings 12 from the greenery are retained within the now-continuous body 110 (due to the closing of the opening 112) and can be moved and disposed of as necessary, as seen in FIG. 4.

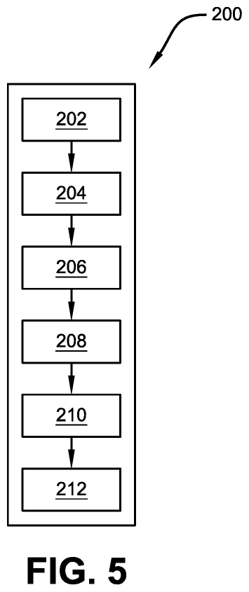

The present invention is also comprised of a method of using 200 the device 100, as seen in FIG. 5. First, a device 100 is provided comprised of a body 110 comprised of a central opening 112 and a perimeter edge 150 with at least one fastener 152 [Step 202]. Then, the central opening 112 can be placed around apiece of greenery 10 from above [Step 204]. Next, the greenery 10 can be trimmed, wherein the trimmings 12 are collected on the body 110 [Step 206]. Next, the body 110 can be lifted upward such that the body 110 no longer surrounds the greenery 10, and while the trimmings 12 remain on the body 110 [Step 208]. Then, the edge 114 of the central opening 112 can be secured to itself using at least one fastener 116 positioned on the edge 114 [Step 210]. Finally, the perimeter edge 150 of the body 110 can be attached to itself via at least one fastener 152 positioned on the edge 150 to form the body 110 into a bag-like shape that retains the trimmings 12 [Step 212].

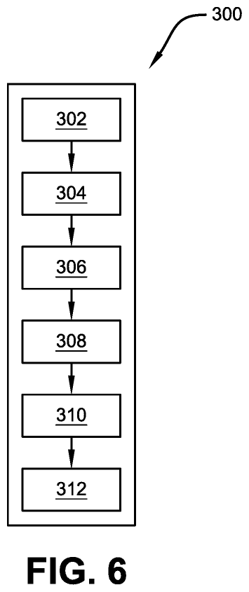

The present invention is also comprised of a second method of using 200 the device 100, as seen in FIG. 6. First, a device 100 is provided comprised of a body 110 comprised of a central opening 112, at least one slit 120, and a perimeter edge 150 with at least one fastener 152 [Step 302]. Then, the central opening 112 can be placed around a piece of greenery 10 by un-attaching a first edge 130 of the slit 120 from a second edge 140 of the slit 120 and then reattaching the first edge 130 to the second edge 140 via at least one fastener 132,142 after the opening 112 surrounds the greenery 10 [Step 304]. Next, the greenery 10 can be trimmed, wherein the trimmings 12 are collected on the body 110 [Step 306]. Next, the body 110 can be lifted upward such that the body 110 no longer surrounds the greenery 10, while the trimmings 12 remain on the body 110 [Step 308]. Next, the edge 114 of the central opening 112 can be secured to itself using at least one fastener 116 on the edge 114 [Step 310]. Finally, the perimeter edge 150 of the body 110 can be attached to itself via at least one fastener 152 of the edge 150 to form the body 110 into a bag-like shape that retains the trimmings 12 [Step 312].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “trimmings collection skirt device” and “device” are interchangeable and refer to the trimmings collection skirt device 100 of the present invention.

Notwithstanding the forgoing, the trimmings collection skirt device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the trimmings collection skirt device 100 as shown in the FIGS. are for illustrative purposes only, and that many other sizes and shapes of the trimmings collection skirt device 100 are well within the scope of the present disclosure. Although the dimensions of the trimmings collection skirt device 100 are important design parameters for user convenience, the trimmings collection skirt device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A trimmings collection skirt device comprising:
a body comprised of a central opening;
a first fastener positioned on a first edge of the central opening; and
a second fastener positioned on a second edge of the body.

2. The trimmings collection skirt device of claim 1, wherein the first fastener is comprised of a zipper.

3. The trimmings collection skirt device of claim 1, wherein the second fastener is comprised of a zipper.

4. The trimmings collection skirt device of claim 1, wherein the first fastener attaches to itself.

5. The trimmings collection skirt device of claim 1, wherein the second fastener attaches to itself.

6. The trimmings collection skirt device of claim 1, wherein the body is comprised of a circular shape.

7. A trimmings collection skirt device comprising:
a body comprised of a central opening and a slit;
a first fastener positioned on a first edge of the central opening; and
a second fastener positioned on a second edge of the body.

8. The trimmings collection skirt device of claim 7, wherein the slit is comprised of a first slit edge.

9. The trimmings collection skirt device of claim 8, wherein the first slit edge is comprised of a first slit edge fastener.

10. The trimmings collection skirt device of claim 7, wherein the slit is comprised of a second slit edge.

11. The trimmings collection skirt device of claim 10, wherein the second slit edge is comprised of a second slit edge fastener.

12. The trimmings collection skirt device of claim 7, wherein the first fastener is comprised of a zipper.

13. The trimmings collection skirt device of claim 7, wherein the second fastener is comprised of a drawstring.

14. The trimmings collection skirt device of claim 7, wherein the first fastener attaches to itself.

15. The trimmings collection skirt device of claim 7, wherein the second fastener attaches to itself.

16. A method of using a trimmings collection skirt device, the method comprising the following steps:
providing a trimmings collection skirt device comprised of a central opening comprised of a first fastener and a perimeter edge comprised of a second fastener;
placing the central opening around a piece of greenery;
trimming the piece of greenery such that a trimming of the piece of greenery is collected on the body;
removing the body from around the piece of greenery;
attaching the first fastener to itself to close the central opening; and
attaching the second fastener to itself to secure the trimmings inside the body.

17. The method of using a trimmings collection skirt device of claim 16, wherein the body is comprised of a slit comprised of a first slit edge and a second slit edge.

18. The method of using a trimmings collection skirt device of claim 17 further comprised of a step of attaching the first slit edge to the second slit edge.

19. The method of using a trimmings collection skirt device of claim 17 further comprised of a step of un-attaching the first slit edge from the second slit edge.

20. The method of using a trimmings collection skirt device of claim 16, wherein the second fastener is comprised of a drawstring.
